(19) United States
(12) Patent Application Publication
(10) Pub. No.: US 2025/0007690 A1
(43) Pub. Date: Jan. 2, 2025

(54) METHOD, APPARATUS, AND COMPUTER-READABLE MEDIUM FOR ORDER PRESERVING ENCRYPTION OF A PLAINTEXT VALUE

(71) Applicant: INFORMATICA LLC, Redwood City, CA (US)

(72) Inventors: Igor BALABINE, Menlo Park, CA (US); Adrian IACOBET, Oshawa (CA)

(21) Appl. No.: 18/477,839

(22) Filed: Sep. 29, 2023

Related U.S. Application Data
(60) Provisional application No. 63/524,431, filed on Jun. 30, 2023.

(51) Int. Cl. H04L 9/06

(52) U.S. Cl. CPC H04L 9/0618

(57) ABSTRACT

A method executed by one or more computing devices for order preserving encryption of a plaintext value includes storing a plaintext value comprising a plurality of bits arranged in predefined order and dividing the plaintext value into a plurality of ordered chunks of plaintext, wherein an initial ordered chunk of plaintext comprises an initial portion of bits and each subsequent ordered chunk of plaintext comprises a subsequent portion of bits. The method further includes encrypting, by an order preserving encryption, each ordered chunk of plaintext to generate a plurality of ciphertext chunks comprising a plurality of ciphertext bits. Lastly, the method includes concatenating the plurality of ciphertext chunks with one another to generate a ciphertext value. A decryption template can be generated to identify a length of the chunks of plaintext and ciphertext and a sign adjustment of the plaintext.

### CROSS-REFERENCE TO RELATED APPLICATIONS

This application claims priority to U.S. Provisional Patent Application No. 63/524,431 filed on Jun. 30, 2023 under 35 U.S.C. § 120, the disclosure of which is incorporated by reference herein.

### FIELD

The present disclosure relates generally to data encryption and specifically to Order Preserving Encryption.

### BACKGROUND

Order Preserving Encryption (OPE) is a cryptographic technique that retains the order of the original plaintext (i.e. an unencrypted value) in a derived ciphertext (i.e., an encrypted value). For example, an OPE encrypted character string representing a credit card number would preserve the order in which the digits of the credit card number are arranged.

### SUMMARY

In some aspects, the present disclosure relates to a method executed by one or more computing devices for efficiently indexing encrypted data, the method comprising: storing a plaintext value comprising a plurality of bits arranged in a predefined order; dividing the plaintext value into a plurality of ordered chunks of plaintext, wherein an initial ordered chunk of plaintext comprises an initial portion of bits in the plurality of bits and wherein each subsequent ordered chunk of plaintext comprises a subsequent portion of bits in the plurality of bits; encrypting, by an order preserving encryption algorithm, each ordered chunk of plaintext to generate a plurality of ciphertext chunks, each ciphertext chunk comprising a plurality of ciphertext bits; and concatenating the plurality of ciphertext chunks with one another to generate a ciphertext value.

The step of dividing the plaintext value into a plurality of ordered chunks of plaintext can include interpreting one or more of the plurality of ordered chunks of plaintext as an integer value; determining that the integer value is a negative value; and multiplying the integer value by negative one if the value is negative.

The method can further include the steps of generating a plurality of decryption templates, each decryption template corresponding to a respective ordered chunk of plaintext, wherein the decryption template comprises data about a length of the respective ordered chunk of plaintext, data about a length of a respective chunk of ciphertext corresponding to the respective ordered chunk of plaintext, and a flag indicating whether an integer representation of a respective chunk of plaintext is negative.

The method can further include the steps of concatenating the plurality of decryption templates to generate a concatenated decryption template and encrypting, by a standard encryption algorithm, the concatenated decryption template to generate an encrypted template.

The method can further include the steps of decrypting the encrypted template to generate the concatenated decryption template; dividing the ciphertext value into the plurality of ciphertext chunks and dividing the concatenated decryption template into the plurality of decryption templates, wherein a length of each ciphertext chunk is determined from each respective decryption template in the plurality of decryption templates; decrypting the plurality of ciphertext chunks based at least in part on each respective decryption template to generate the plurality of chunks of plaintext; and generating the plaintext value by concatenating the plurality of chunks of plaintext with one another.

In some aspects, the plaintext value can be a floating-point value having a sign bit, a plurality of exponent bits, and a plurality of fraction bits. The initial chunk of ordered plaintext further can include an ordinal followed by the sign bit and the plurality of exponent bits of the floating-point value, and each subsequent ordered chunk of plaintext can include an ordinal byte and a portion of the plurality of fraction bits of the floating-point value.

In some aspect, the plurality of fraction bits can be divided among three ordered chunks of plaintext.

In some aspects, the plurality of fraction bits can be divided among two ordered chunks of plaintext.

In some aspects, the order preserving encryption is one-way encryption.

In some aspects, the present disclosure relates to an apparatus for order preserving encryption of a plaintext value. The apparatus includes one or more processors and one or more memories operatively coupled to at least one of the one or more processors and having instructions stored thereon that, when executed by at least one of the one or more processors, cause at least one of the one or more processors to perform any of the methods described above.

In some aspects, the present disclosure relates to at least one non-transitory computer-readable medium storing computer-readable instructions that, when executed by at least one of one or more computing devices, cause at least one of the one or more computing devices to perform any of the methods described above.

### BRIEF DESCRIPTION OF THE DRAWINGS

FIG. 1 illustrates a flowchart for order preserving encryption of a plaintext value according to an exemplary embodiment.

FIG. 2 illustrates an example of order preserving encryption of a plaintext value according to an exemplary embodiment.

FIG. 3 illustrates an example of a decryption template according to an exemplary embodiment.

FIG. 4 illustrates a flowchart of a method for decrypting ciphertext that is generated using the order preserving encryption described herein according to an exemplary embodiment.

FIG. 5 illustrates an example of decrypting ciphertext that is generated using the order preserving encryption described herein according to an exemplary embodiment.

FIG. 6 illustrates an example of order preserving encryption of a floating-point value according to an exemplary embodiment.

FIG. 7 illustrates a format of Institute of Electrical and Electronics Engineers (IEEE) 754 standard floating-point values.

FIG. 8 illustrates a specialized computing environment for order preserving encryption of a plaintext value and decryption of a ciphertext value generated by the order preserving encryption of a plaintext value according to an exemplary embodiment.

### DETAILED DESCRIPTION

Order preserving encryption (OPE) has a number of advantages. Ciphertext created using OPE can be indexed, searched, and sorted just like the corresponding plaintext, making it useful for database operations and queries, such as in a relational database. OPE allows for all of “exact”, “greater than” and “less than”, and “range” comparison functions to operate on the encrypted data. When applied to a database, all data fields used as keys in indices are encrypted with an OPE algorithm before onset of any database operations. Once a database query is executed, parameters of the query are encrypted with the same OPE algorithm and the encrypted values are queried using the encrypted parameters.

Existing OPE algorithms have a number of drawbacks. For example, in practice, data sets regularly include alphanumeric, numeric, and floating-point data values, but many known OPE algorithms are applicable to integer numeric values only. Further, known OPE algorithms do not scale efficiently as a length of the plaintext value increases. The duration of an OPE encryption increases exponentially with the length of the plaintext value being encrypted. At certain plaintext value lengths, e.g., 20-bytes long or larger, known OPE algorithms cannot produce a ciphertext value in a practical amount of time.

Furthermore, some OPE algorithms require upfront knowledge of the input domain due to the presence of weighting values associated with the input data, and cryptographic indistinguishability can only be achieved in static data sets.

Due to the many drawbacks of existing OPE technologies, including those discussed above, the advantages of OPE cannot be effectively leveraged for large and/or heterogenous data sets. As such, there exists a need to develop an OPE process that can apply to alphanumeric, numeric, and floating-point data values that scale efficiently as the length of the unencrypted values increases. Further, there is a need to define an OPE process that encrypts longer plaintext values in a practical amount of time while maintaining precision and reducing errors caused by rounding. Lastly, there exists a need for an OPE process that does not require upfront knowledge of the input domain that nevertheless can achieve cryptographic indistinguishability in both static data sets and dynamic data sets.

To overcome the aforementioned drawbacks of known OPE algorithms stemming from the limitations to the size of a data object to be encrypted, the present disclosure teaches partitioning or dividing a plaintext data object into a plurality of chunks of plaintext, interpreting each chunk of plaintext as an integer value, encrypting each chunk of plaintext to generate a corresponding chunk of cyphertext, and then concatenating the resulting chunks of ciphertext into a single ciphertext value. The resulting ciphertext value preserves the order of the plaintext value in the ciphertext.

By encrypting chunks of a pre-determined size separately from the other chunks instead of encrypting the entire plaintext value at once, the processing delays experienced in the prior art are greatly reduced, enabling OPE of large plaintext values without loss of precision. Further, by encrypting chunks of a pre-determined size, knowledge of the input domain is not required.

While methods, apparatuses, and computer-readable media are described herein by way of examples and embodiments, those skilled in the art recognize that methods, apparatuses, and computer-readable media for order preserving encryption of a plaintext value are not limited to the embodiments or drawings described. It should be understood that the drawings and description are not intended to be limited to the particular forms disclosed. Rather, the intention is to cover all modifications, equivalents, and alternatives falling within the spirit and scope of the disclosure and appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” “includes”, “comprise,” “comprises,” and “comprising” mean including, but not limited to. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

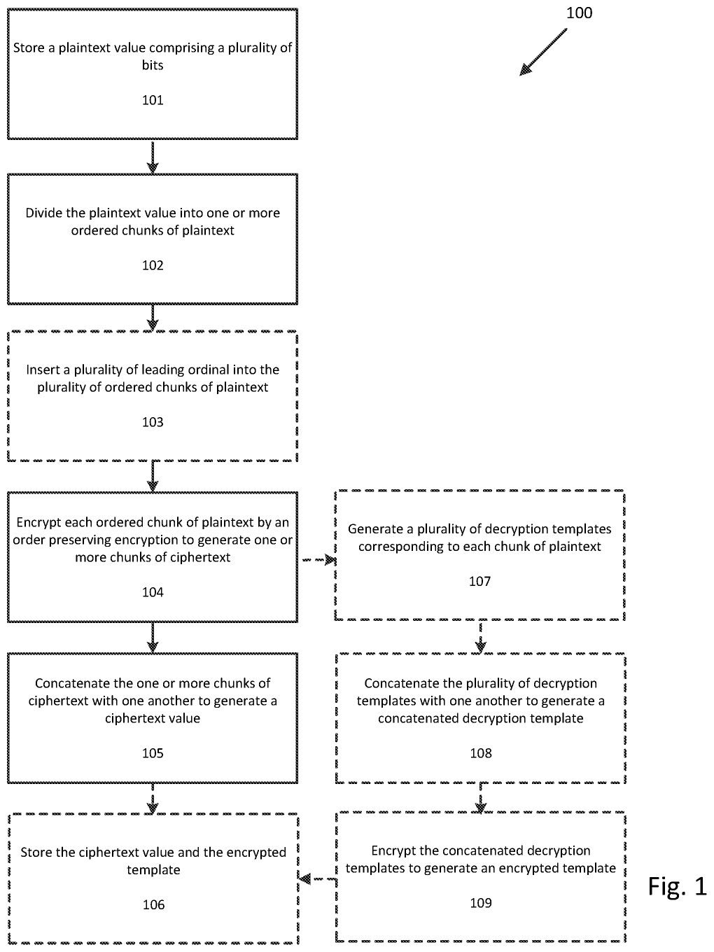

FIG. 1 illustrates a flow chart of a method 100 for order preserving encryption of a plaintext value according to an exemplary embodiment.

At step 101, a plaintext value is stored. The plaintext value can be received from an executing process and/or as part of a request. For example, the plaintext value can be passed in as an argument in a function call (such as an encryption request). The plaintext value can also be stored in a database and passed to an encryption as an argument by reference, meaning a memory location of the stored plaintext value is passed to the function.

The plaintext value can be any type of numerical data type that is represented using a predefined number and/or range of values within a computer storage system, such as a “byte” type, a “byte array” type, an “integer” type, a “floating point” (float) type, a “smallint” type, a “decimal” type, a “numeric” type, a “real” type, and/or a “double” type. It is understood that the plaintext value can represent any number and any binary numerical value. Therefore, reference to a “binary” aspect of the plaintext value refers to the bits used to store all values having the same data type as the plaintext value.

The plaintext value comprises a plurality of bits. In the case of an integer data type as is commonly used in SQL databases, the plaintext value can comprise 8, 16, 32, or 64 bits. In the case of a float data type, the plaintext value can comprise 32 bits or 64 bits. In the case of byte array data type, the plaintext value length is theoretically unlimited. Many variations are possible, and these examples are not intended to be limiting.

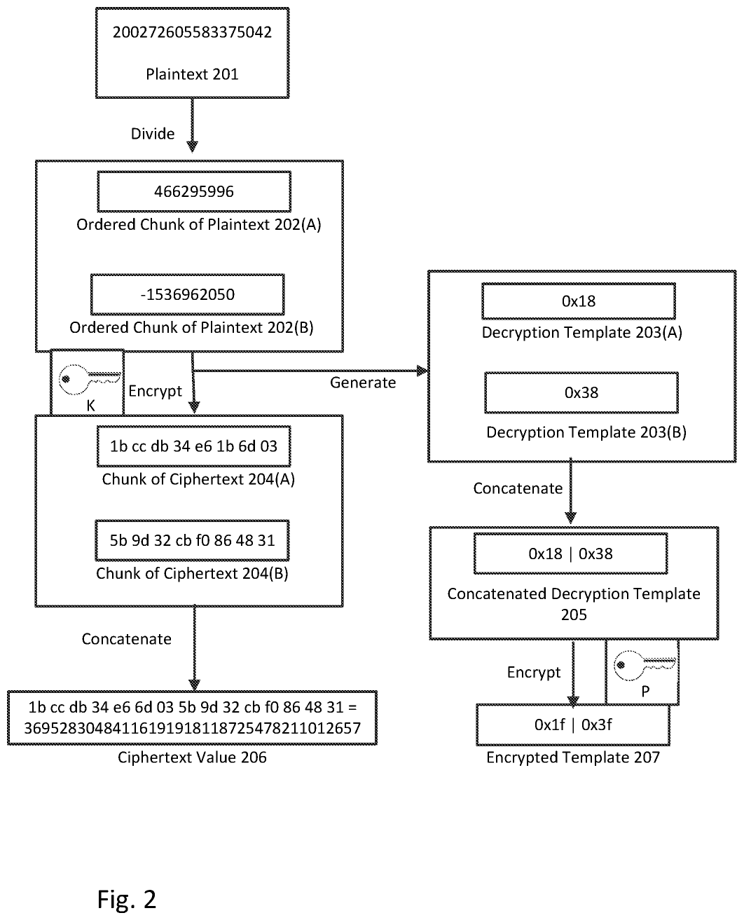

FIG. 2 illustrates an example of an order preserving encryption of a plaintext value according to an exemplary embodiment.

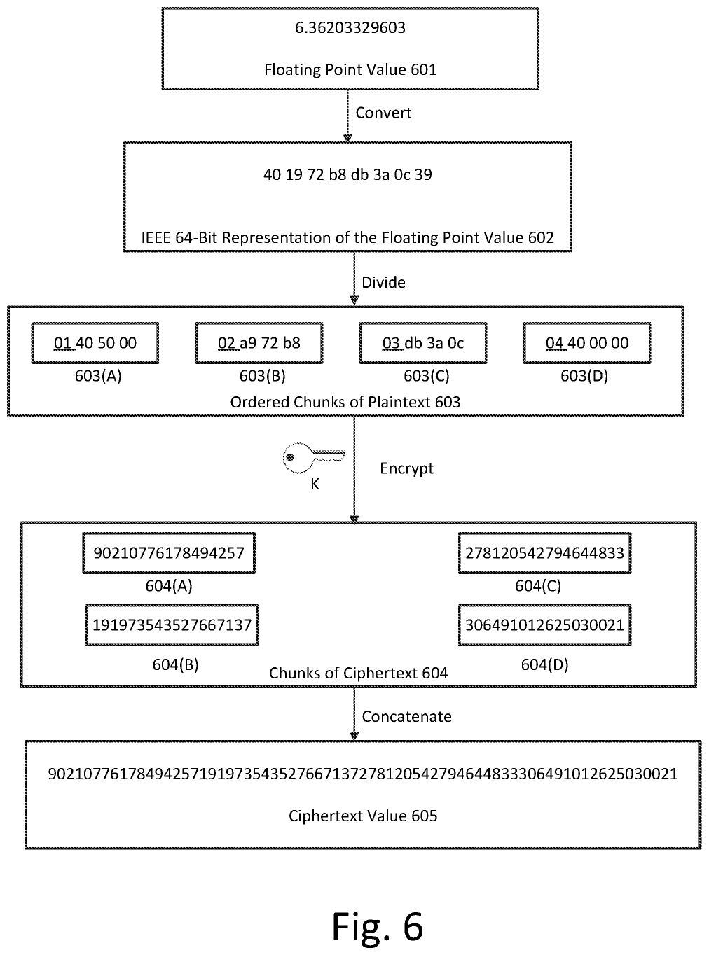

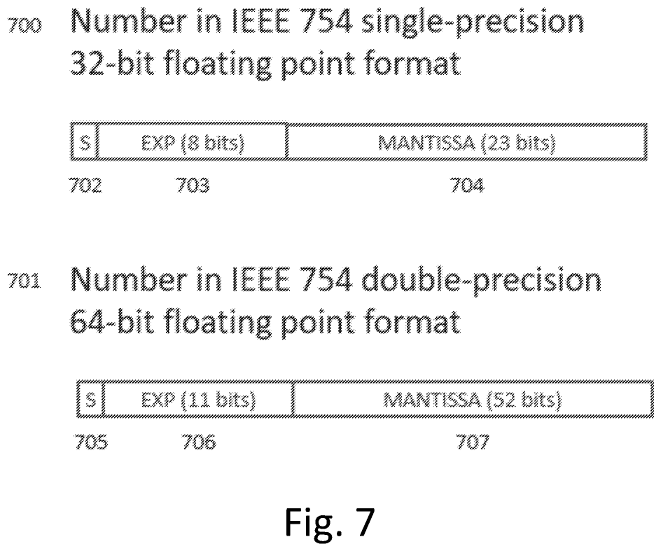

As shown in FIG. 2, the stored plaintext value can be 64-bit long plaintext value 201 in integer representation. However, in other embodiments, the plaintext value can be a byte, a byte array, an 8, 16 or 32-bit integer, integers of unlimited length (e.g., a Java BigInteger), an IEEE 754 formatted 64-bit floating point value (see, e.g., FIGS. 6 and 7), and unlimited precision decimals (Java BigDecimal). In other words, there is no limit to the length of the plaintext value 201 to which the exemplary order preserving encryption illustrated in FIG. 2 can be applied to.

Returning to FIG. 1, at step 102, the plaintext value is divided into a plurality of ordered chunks of plaintext. These ordered chunks of plaintext can comprise a fixed number of bits each. In the exemplary embodiment described herein, without a limitation, a domain range of the plaintext chunks interpreted as integer values in the two's complement representation is [−2³¹, 2³¹−1], represented by 4 bytes. In the exemplary embodiment we select a codomain of the resulting chunks of ciphertext is larger than the domain of the ordered chunks of plaintext. In the exemplary embodiment shown in FIG. 2, the codomain of each resulting chunk of ciphertext is [2³², 2⁶⁴−1], represented by 8 bytes and interpreted as an unsigned integer value. It is appreciated that in alternative embodiments, the domain range of plaintext chunks can be selected as an unsigned integer value represented by 4 bytes, a signed integer value of size other than 4 bytes, or an unsigned integer value of other size. It is also appreciated that in some embodiments, a codomain of the ciphertext chunks can be other than 8-byte values and can even be smaller than the plaintext domain range or the same size, despite the exemplary embodiment describing a codomain of the chunks of ciphertext that is larger than the domain range of the plaintext chunks.

FIG. 2 illustrates the step of dividing the plaintext value into a plurality of ordered chunks of plaintext. As shown in FIG. 2, plaintext value 201 is divided into two ordered chunks of plaintext 202(A) and 202(B), each being 32-bits (4 bytes) long in this exemplary embodiment. In the illustrated embodiment, ordered chunk of plaintext 202A) is interpreted as a signed 32-bit integer value of “466295996” and ordered chunk of plaintext 202(B) is interpreted a signed 32-bit integer value of “−1536962050”. Because ordered chunk of plaintext 20(B) is interpreted as a negative integer value, due to the use of the selected OPE algorithm, it must be converted to a positive value prior to encryption by multiplying it by −1.

However, in alternative embodiments, plaintext value 201 may be divided into more than two ordered chunks of plaintext, depending on the length of plaintext value 201 and the desired size of each ordered chunk of plaintext. For example, in embodiments storing a plaintext value that is 128 bits in length, dividing the plaintext value can include dividing it into four ordered chunks of plaintext, each being 32-bits long, or can include dividing the plaintext value into two ordered chunks of plaintext, each being 64-bits long. It will be appreciated by a person of ordinary skill in the art that the length of the plaintext value is not limiting to the order preserving encryption according to the teachings of this disclosure.

In fact, the method described herein can be applied to plaintext values of any length, and reliance on the exemplary embodiment described herein is not meant to be limiting. Consider, for example, two plaintexts P₁=a₁|b₁ and P₂=a₂|b₂, where lexicographically a₁≥a₂ and “|” denotes concatenation. By definition of an OPE transformation E, E(a₁)≥E(a₂), for any b₁ and b₂, E(a₁)|E(b₁)≥E(a₂)|E(b₂). It therefore follows that the novel OPE technique according to the present disclosure permits order preserving encryption of plaintext data elements of unlimited length by breaking that plaintext data element down into smaller, ordered chunks that are encrypted and then rejoined together to form a ciphertext value for the full plaintext data element. In the exemplary embodiment shown in FIG. 2, a relationship between plaintext value 201 and ordered chunks of plaintext 202(A) and 202(B) is 201=202(A)|202(B).

Next, at an optional step 103 in FIG. 1, a plurality of leading ordinals is inserted into the plurality of ordered chunks of plaintext. Each leading ordinal indicates a relative position of each ordered chunk of plaintext relative to the other ordered chunks of plaintext and as they are ordered in the plaintext value. An exemplary embodiment of inserting a plurality of leading ordinal is described with respect to FIG. 6 below.

Next, at step 104 in FIG. 1, each ordered chunk of plaintext of the plurality of chunks of plaintext is encrypted using a cryptographic key K by an order preserving encryption (OPE) algorithm to generate a plurality of chunks of ciphertext, each chunk of ciphertext comprising a plurality of ciphertext bits.

In the exemplary embodiment shown in FIG. 2, an exemplary OPE algorithm constructs a cryptographic key K by generating pseudo-random bytes using a cryptographically strong random bytes generator or any other FIPS approved symmetric key generation method. In the exemplary embodiment, a 128-bit cryptographic key K is then used to generate pseudo-random permutations utilizing an AES (advanced encryption standard) cipher in an output feedback block cipher mode (AES-OFB). Each plaintext value (i.e., each chunk of plaintext value in this exemplary embodiment) is combined with a pseudo-random value generated by the block cipher, and a binary search is performed on the plaintext domain converging on the plaintext value. The corresponding ciphertext value is determined by sampling a hypergeometric probability distribution and is then mapped to the plaintext. It will be appreciated by persons of ordinary skill in the art that the size of the cryptographic key K is not limited to 128 bits, and may instead be, for example, a 256-bit key without departing from the teachings of this disclosure. Further, an alternative AES block cipher streaming mode, such as AES-CTR (AES counter) and AES-CFB (AES cipher feedback), may be used without departing from the teachings of this disclosure. By encrypting each chunk of plaintext separate from the other chunks of plaintext in the plurality of chunks of plaintext, the OPE consistent with this disclosure allows for parallelism in use, which improves the efficiency of the OPE as compared to known processes that do not divide the plaintext into a plurality of chunks.

It will be appreciated that the method for order preserving encryption described herein does not depend on the selected OPE algorithm, and that any OPE algorithm can be applied without departing from the scope of this disclosure.

FIG. 2 illustrates encrypting a plurality of ordered chunks of plaintext using a cryptographic key K to generate a plurality of chunks of ciphertext comprising a plurality of ciphertext bits according to an exemplary embodiment. As shown, ordered chunk of plaintext 202(A) is OPE encrypted by key K and a chunk of ciphertext 204(A) is generated. Similarly, ordered chunk of plaintext 202(B) is OPE encrypted with key K and a chunk of ciphertext 204(B) is generated. In the exemplary embodiment shown, the encryption produces chunks of ciphertext that are larger than the ordered chunks of plaintext. In the illustrated embodiment, each chunk of ciphertext 204(A) and 204(B) is 8 bytes in length and comprise 64 bits (i.e., the ciphertext domain range is [2³², 2⁶⁴−1]), as compared to the corresponding ordered chunk of plaintext 202(A) and 202(B) that are each 4 bytes in length and comprise 32 bits (i.e., the plaintext domain range is [−2³¹, 2³¹−1]). Here, ordered chunk of plaintext 202(A) is encrypted from “466295996” to “1b cc db 34 e6 1b 6d 03” (chunk of ciphertext 204(A)) and ordered chunk of plaintext 202(B) is encrypted from “−1536962050” to “5b 9d 32 cb f0 86 48 31” (chunk of ciphertext 204(B)).

At step 105 in FIG. 1, the plurality of chunks of ciphertext are concatenated with one another. Concatenating the plurality of chunks of ciphertext includes joining each chunk of ciphertext end-to-end in the same order as the corresponding ordered chunks of plaintext are arranged in the plaintext value.

FIG. 2 illustrates concatenating the plurality of chunks of ciphertext to generate a ciphertext value. As shown, chunk of ciphertext 204(A) is concatenated with 204(B) by joining the plurality of ciphertext bits of 204(A) end-to-end with the plurality of ciphertext bits of 204(B) in the same order as the corresponding ordered chunks of plaintext to generate a ciphertext value 206. As discussed above, the ordinal relationship between plaintext value 201 and chunks of plaintext 202(A) and 202(B) is 201=202(A)|202(B). Therefore, chunks of ciphertext 204(A) and 204(B) are concatenated according to 204(A)|204(B)=206, where 206 is the ciphertext value.

In the exemplary embodiment shown in FIG. 2, concatenating chunks of ciphertext 204(A) and 204(B) according to 204(A)|204(B) generates a ciphertext value 206 of “1b cc db 34 e6 1b 6d 03 5b 9d 32 cb f0 86 48 31” that is 16 bytes long and comprises 128-bits. Ciphertext value 206 is twice as large as plaintext value 201, which is 8 bytes comprising 64-bits. If desired, ciphertext value 206 can be converted to a corresponding integer representation. In the exemplary embodiment shown in FIG. 2, the integer representation of ciphertext value 206 is “36952830484116191918118725478211012657.”

In some embodiments, method 100 may further include step 106 of storing the ciphertext value. Ciphertext value can be stored in, for example, a relational database in place of the plaintext value, or in any other known database.

It is appreciated that, while the OPE described herein divides a plaintext value into a plurality of chunks of equal size, the fact that this OPE can be applied to a plaintext value of any length means that, in some embodiments, there may be some overflow or underflow in a last chunk of plaintext and/or in a last chunk of ciphertext. For example, in some embodiments, the ciphertext value may be too large for the ciphertext domain, corresponding to an overflow, necessitating a last chunk of ciphertext that is not the fixed size of the other chunks of ciphertext. And in other embodiments, the ciphertext value may be too small for the ciphertext domain, corresponding to an underflow, in which case there will be blank bytes in the last chunk of the plurality of chunks of ciphertext. The same can occur with the chunks of plaintext where a plaintext value does not match the domain size of the chunks of plaintext. In each instance, encryption and decryption can only be achieved if an adjustment is made to the OPE algorithm to account for this overflow or underflow. Having such variable size of the data objects of one or both domains (i.e., the domain of the plaintext value and the domain of the ciphertext value) affects the ordering of the ciphertext value, which risks losing the order preservation of the ciphertext value, thus making OPE impossible. As such, it is necessary to track plaintext and ciphertext lengths to inform whether an overflow exists, in which case the OPE algorithm can adjust by adding more bytes, or whether an underflow exists, in which case the OPE algorithm can attribute the blank bytes in the ciphertext to the underflow.

Further complications exist where the underlying OPE algorithm is limited to non-negative integer plaintext values. It is appreciated that dividing the plaintext into a plurality of chunks of plaintext can result in one or more chunks being interpreted as negative integer values. In such embodiments, when a leftmost bit in the leftmost byte of a chunk of plaintext is a value of 1, the chunk of plaintext represents a negative integer number. For these chunks of plaintext, the chunk is multiplied by a negative 1 to make it a positive number that the particular OPE algorithm can encrypt.

To account for overflow and underflow, and to account for a sign change, in some embodiments, method 100 can further include step 107 of generating a plurality of decryption templates corresponding to the plurality of ordered chunks of plaintext. Each decryption template is associated with a particular ordered chunk of plaintext and contains characteristics of the particular ordered chunk of plaintext and the associated chunk of ciphertext. Each decryption template can include, for example and without limitation, information about the length of the respective chunk of plaintext and the length of the respective chunk of ciphertext, respectively, and a flag indicating whether an integer representation of the respective chunk of plaintext was adjusted prior to encryption, such as by a sign adjustment. As illustrated in FIG. 1, step 107 of generating a plurality of decryption templates is performed with step 104 of encrypting the plurality of chunks of ordered plaintext.

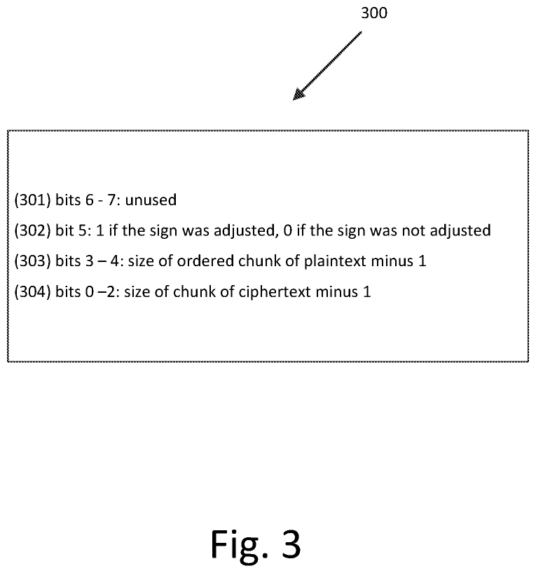

A structure of an exemplary decryption template is illustrated in FIG. 3. In the exemplary embodiment, a decryption template 300 is 1 byte in length. Bits 6-7 (301) of decryption template 300 are unused, where bit 7 is the most significant bit (i.e., the leftmost bit). Bit 5 (302) serves as the flag indicating whether the integer representation of the corresponding ordered chunk of plaintext was adjusted prior to encryption. For example, if the sign of the ordered chunk of plaintext was adjusted, then bit 5 (302) is a value of 1. If the sign of the ordered chunk of plaintext was not adjusted, then bit 5 (302) is a value of 0. Bits 3-4 (303) can represent the size of the plaintext value in the corresponding ordered chunk of plaintext minus 1, and bits 0-2 (304) can represent the size of the ciphertext value in the corresponding chunk of ciphertext minus 1. Both bits 3-4 (303) and bits 0-2 (304) serve as indicators of whether there is overflow or underflow in the ordered chunk of plaintext and/or in the chunk of ciphertext associated with decryption template 300.

As shown in FIG. 2, a decryption template can be generated for each ordered chunk of plaintext. In this exemplary embodiment, a decryption template 203(A) is generated for ordered chunk of plaintext 202(A) and a decryption template 203(B) is generated for ordered chunk of plaintext 202(B). Following the exemplary decryption template 300 shown in FIG. 3, bit 5 (302) of decryption template 203(A) is 0 because the sign of chunk of plaintext 202(A) was not adjusted when it was converted to ordered chunk of plaintext 202(A). In contrast, bit 5 (302) of decryption template 203(B) is 1 because the sign of chunk of plaintext 202(B) was changed from negative to positive when it was converted to ordered chunk of plaintext 202(B). Bits 3-4 (303) of decryption template 203(A) are “11” representing the length of ordered chunk of plaintext 202(A) minus 1 (i.e., 4 bytes−1=3), and bits 3-4 (303) of decryption template 203(B) are also “11” representing the length of ordered chunk of plaintext 202(B) minus 1 (i.e., 4 bytes−1=3). Bits 0-2 (304) of decryption template 203(A) are “111” representing the length of chunk of ciphertext 204 (A) minus 1 (i.e., 8 bytes−1=7), and bits 0-2 (304) of decryption template 203(B) are also “111” representing the length of chunk of ciphertext 204(B) (i.e., 8 bytes−1=7).

In some embodiment decryption templates 203(A) and 203(B) can be generated at the beginning of the encryption of ordered chunks of plaintext 202(A) and 202(B) but before the encryption is complete. In such embodiments, the length of the corresponding ciphertext may not be known at the time of generation of the decryption templates. Thus, initially, the decryption templates do not yet include values for bits 0-2 that represent the length of the corresponding chunk of ciphertext minus 1. Once encryption of the ordered chunks of plaintext are completed and the plurality of chunks of ciphertext are generated, bits 0-2 of each decryption template is updated with values representing the length of each corresponding chunk of ciphertext.

It will be appreciated by a person of ordinary skill in the art that template 300 is merely exemplary and that the bits in the decryption template may be arranged in a different way to include the information about the length of the ordered chunk of plaintext, the length of the chunk of ciphertext, and the flag identifying a sign change without departing from the scope of this disclosure.

Returning to method 100 and FIG. 1, after generating the plurality of decryption templates at step 107, the plurality of decryption templates are concatenated with one another at step 108 to generate a concatenated decryption template. Concatenating the plurality of decryption templates includes joining each decryption template end-to-end in the same order as the corresponding ordered chunks of plaintext.

As shown in the exemplary embodiment of FIG. 2, the plurality of decryption templates are concatenated together to form a concatenated decryption template. As shown, decryption templates 203(A) and 203(B) are concatenated together to generate a concatenated decryption template 205. As discussed above, an ordinal relationship between the ordered chunks of plaintext values corresponding with the encrypted templates 202(A) and 202(B) (e.g., chunks of plaintext values 202(A) and 202(B)) is 201=202(A)|202(B). Decryption templates 203(A) and 203(B) are therefore concatenated according to the same ordinal relationship such that concatenated decryption template 205=203(A)|203(B). In the exemplary embodiment shown in FIG. 2, concatenating decryption templates 203(A) and 203(B) according to 203(A)|203(B) generates a concatenated decryption template 205 of 0x18|0x38.

Next, at step 109, the concatenated decryption template is encrypted to generate an encrypted template. The concatenated decryption template can be encrypted with an arbitrary cryptographic key P, which is a separate cryptographic key than key K, generated using a standard encryption method, such as an AES-GCM (Galois Counter) block cipher encryption mode, a stream cipher encryption mode, or a public key encryption mode. Encrypting the concatenated decryption template with a cryptographic key P that is separate from the cryptographic key K used to encrypt the plurality of ordered chunks of plaintext improves the overall security of the encryption because a malicious actor now needs to break 2 cryptographic keys to access the plaintext values that have been encrypted. However, it is possible to implement method 100 with a single cryptographic key for both the ordered chunks of plaintext and the plurality of decryption templates.

FIG. 2 illustrates encrypting the concatenated decryption template using a cryptographic key P to generate an encrypted template according to an exemplary embodiment. As shown, cryptographic key P encrypts concatenated decryption template 205 represented as 0x18|0x38 to generate an encrypted template 207 represented as 0x1f|0x3f.

In some embodiments, step 106 of method 100 shown in FIG. 1 can also include storing the encrypted template. The encrypted template can be stored in, for example, a relational database alongside the ciphertext value stored at step 106, or any other known database.

The resulting ciphertext values are particularly advantageous for use in a relational database precisely because the order of the course plaintext values is preserved in the ciphertext value. OPE encrypted ciphertext allows use of efficient range queries on the encrypted data. OPE also allows indexing and query processing to be done exactly and as efficiently as for unencrypted data because a query just consists of the encryptions of a and b and the server can locate the desired ciphertexts. Further, because the ciphertext is order preserved, a remote relational database on an untrusted server is able to index the encrypted data it receives, in encrypted form, in a data structure that permits efficient range queries (e.g., asking the server to return ciphertexts in the database whose decryptions fall within a given range. OPE can be used in many relational databases used for in-network aggregation on encrypted data in sensor networks and as a tool for applying signal processing techniques to multimedia content protection. Using the resulting ciphertext (e.g., ciphertext value 207) in a relational database guarantees data consistency across instances with the security of encryption, while maintaining the same ability to index and query the encrypted data as unencrypted data in a relational database, and without limitations on the size of the ciphertext or the sourced plaintext.

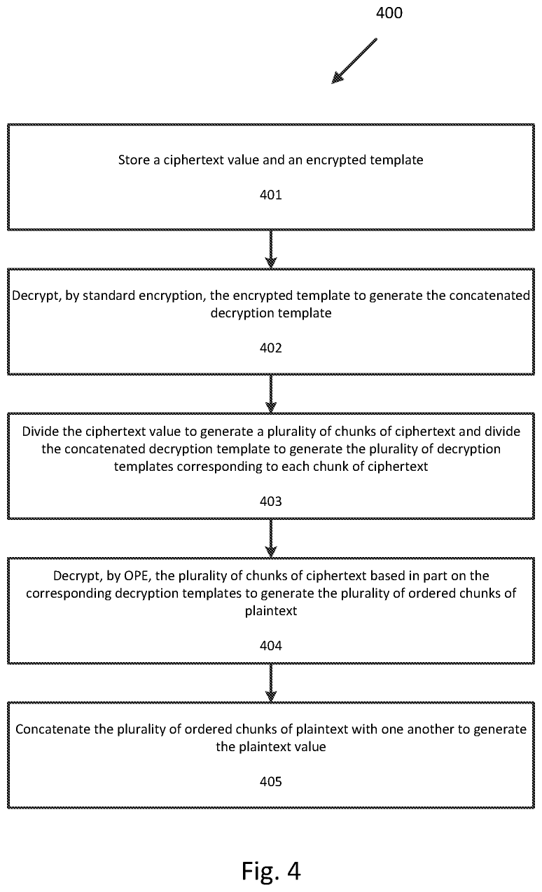

In many instances, it will be necessary to decrypt the ciphertext value generated as a result of method 100. FIG. 4 illustrates an example of a decryption method for decrypting a ciphertext value according to an exemplary embodiment. As shown in FIG. 4, method 400 begins with step 401 of storing a ciphertext value comprising a plurality of bits and a corresponding encrypted template comprising a plurality of bytes. In some embodiments, storing the ciphertext value may include storing the ciphertext value in temporary storage or permanent storage. Further, storing the ciphertext value can include retrieving the ciphertext value and then storing the ciphertext value.

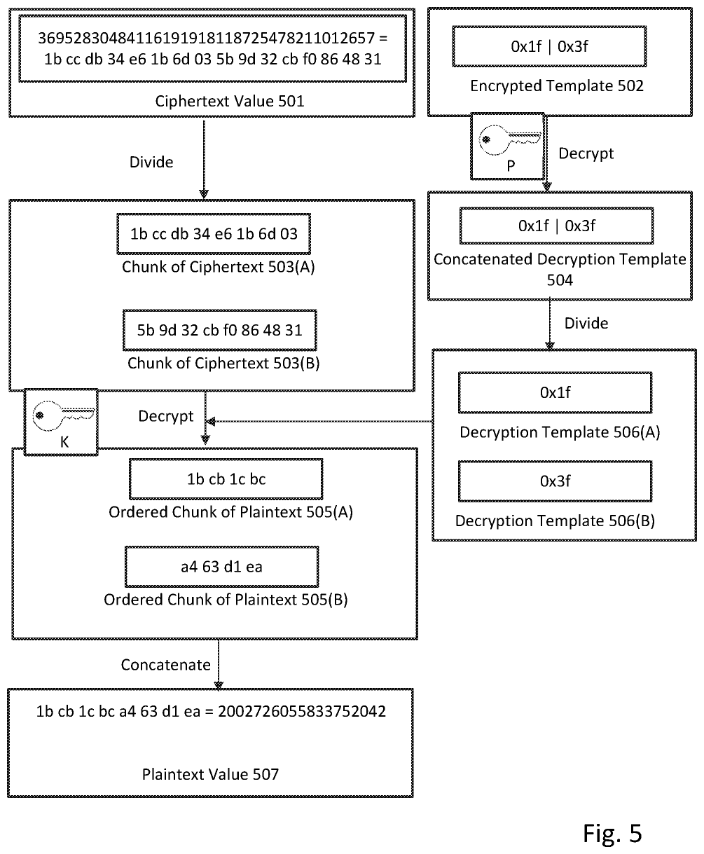

Next, at step 402, the encrypted template is decrypted to generate the concatenated decryption template. In the exemplary embodiment shown in FIG. 5, encrypted template 502 is decrypted using cryptographic key P used to encrypt plurality of decryption templates 203(A) and 203(B) (see FIG. 2) and concatenated decryption template 506 is generated.

An exemplary embodiment of decryption method 400 is illustrated in FIG. 5. As shown, a ciphertext value 501 may have an integer representation of “369528304841161919-18118725478211012657” and a corresponding hexadecimal notation of “1b cc db 34 e6 1b 6d 03 5b 9d 32 cb f0 86 48 31.” Thus, in the exemplary embodiment, ciphertext value 501 is 16 bytes, or 128 bits, long. As further shown, an encrypted template 502 is 0x1f|0x3f.

Encrypted template 502 is then decrypted using cryptographic key P that was used to encrypt the plurality of decryption templates (e.g., decryption templates 203(A) and 203(B) shown in FIG. 2) and a concatenated decryption template 504 is generated. In the exemplary embodiment, concatenated decryption template 504 is 2 bytes in length and represented as 0x1f|0x3f.

At step 403, the ciphertext value and the concatenated decryption template are divided. The ciphertext value is divided into a plurality of chunks of ciphertext of a fixed size (e.g., 8 bytes in this exemplary embodiment) and the concatenated decryption template is divided into a plurality of decryption templates, each 1-byte in length.

As illustrated in the exemplary embodiment shown in FIG. 5, ciphertext value 501 and concatenated decryption template 504 are divided. In this exemplary embodiment, ciphertext value 501 is divided into two chunks of ciphertext 503(A) and 503(B), each chunk having a length of 8 bytes (or 64 bits). In the example embodiment, chunk of ciphertext 503(A) is “1b cc db 34 e6 1b 6d 03”, which corresponds to the left most 8 bytes of ciphertext value 501, and chunk of ciphertext 503 (B) is “5b 9d 32 cb f0 86 48 31”, which corresponds to the remaining 8 bytes of ciphertext value 501.

When the ciphertext value is divided into a plurality of chunks of ciphertext, the concatenated decryption template is referenced to determine the size of each chunk of ciphertext of the plurality of chunks of ciphertext. Because each decryption template that forms the concatenated decryption template is 1-byte each, a size of each chunk of ciphertext is determined by referencing bits 0-2 of each byte in the concatenated decryption template. In the exemplary embodiment shown in FIG. 5, bits 0-2 of the first byte in decryption template 504 (0x1f) is “111” representing 7 bytes, which equals the length of the first chunk of ciphertext 503(A) of ciphertext value 501 minus 1, and bits 0-2 of the second byte in decryption 504 (0x3f) “111” representing 7 bytes, which equals the length of the second chunk of ciphertext (503(B)) of ciphertext value 501 minus 1. Thus, cyphertext 503(A) and ciphertext 503(B) each are a length of 8 bytes.

Similarly, concatenated decryption template 504 is divided into decryption template 506A) represented as 0x1f, which corresponds to the left most byte of concatenated decryption template 504, and decryption template 506(B) represented as 0x3f, which corresponds to the remaining byte of concatenated decryption template 504.

Returning to FIG. 4, the next step 404 of method 400 is to decrypt the plurality of chunks of ciphertext using the plurality of decryption templates to generate the plurality of ordered chunks of plaintext. Because each of the plurality of decryption templates is 1 byte long, and each decryption template corresponds to a chunk of ciphertext of the plurality of chunks of ciphertext, the left most byte of the concatenated decryption template is used to decrypt the first chunk of ciphertext of the plurality of chunks of ciphertext, and each subsequent byte of the concatenated decryption template is used to decrypt each subsequent chunk of ciphertext of the plurality of chunks of ciphertext. And because the ciphertext value was encrypted by order preserving encryption, the left most byte of the concatenated decryption template (i.e., the first bytes of the concatenated decryption template) corresponds to the left most chunk of the ciphertext value (i.e., the first chunk of the ciphertext value), and each subsequent byte of the concatenated decryption template corresponds to each subsequent chunk of ciphertext of the ciphertext value.

As shown in FIG. 5, chunk of ciphertext 503(A) is decrypted using template 506(A), generating an ordered chunk of plaintext 505(A). In this embodiment, ordered chunk of plaintext 505(A), represented as “1b cb 1c bc”, is 4 bytes, or 32 bits, in length, which is half the length of corresponding chunk of ciphertext 503(A), and decryption template 506(A), represented as 0x1f, is 1 byte in length. Similarly, chunk of cyphertext bytes 503(B) is decrypted using template 506(B), generating an ordered chunk of plaintext 505(B). In this embodiment, ordered chunk of plaintext 505(B), represented as “a4 63 d1 ea”, is 4 bytes, or 32 bits, in length, which is half the length of corresponding chunk of ciphertext 503(B), and decryption template 506(B), represented as 0x3f, is 1 byte in length. Because decryption template 506(B) has a sign bit as bit 5, ordered chunk of plaintext 505(B) is multiplied by −1 in step 404 after chunk of ciphertext 505B) is decrypted. Each decryption template 506(A) and 506(A) is referenced to determine the length of each corresponding ordered chunk of plaintext 505(A) and 505(A). Here, each decryption template 506(A) and 506(A) include bits 2-3 of “11” denoting a value of 3 which corresponds to the number of bytes in each corresponding chunk of plaintext minus 1. Thus, the length of each ordered chunk of plaintext is 4 bytes.

Lastly, in step 405, the ordered chunks of plaintext are concatenated with one another to generate a plaintext value. The ordered chunks of plaintext are concatenated according to the ordinal relationship of the corresponding chunks of ciphertext. As shown in the exemplary embodiment in FIG. 5, ordered chunk of plaintext 505(A) and ordered chunk of plaintext 505(B) are concatenated according to the ordinal relationship 505(A)|505(B) because the ordinal relationship of corresponding chunks of ciphertext is 501=503(A)|503(B). Thus, in this exemplary embodiment, plaintext value 507=505(A)|505(B), which results in a plaintext value of 2002726055833752042. This plaintext value 507 matches plaintext value 201 that was originally encrypted by method 100 in FIG. 1.

In some embodiments, it may be desirable to use the OPE described herein without also producing a decryption template. In such embodiments, the OPE would be “one-way” in which a plaintext value is encrypted but decryption is not required. Such an encryption may follow steps 101 through 105 and 106 of method 100 illustrated in FIG. 1 but not execute steps 107 through 109 of generating, encrypting, and concatenating a plurality of decryption templates.

As another exemplary embodiment, FIG. 6 illustrates an exemplary embodiment of this one-way encryption applied to a floating-point plaintext value according to the OPE method described herein. The floating-point value is shown in decimal plaintext 601 (“6. 36203329603”). The decimal plaintext 601 is then converted to an IEEE 754 formatted 64-bit long value 602 (“40 19 72 b8 db 3a Oc 39”), which requires a particular partitioning of the bits of the floating-point value. It will be appreciated that use of a floating-point plaintext value to illustrate an embodiment of one-way encryption is merely exemplary and not limiting. In other embodiments, one-way encryption may be applied to a different type of plaintext value, such as an integer value. Furthermore, this exemplary embodiment does not limit the encryption of a floating-point value to the one-way encryption shown in FIG. 6, and a floating-point value may be encrypted according to the exemplary embodiment described in FIG. 2 and then decrypted according to the exemplary method described in FIG. 4.

FIG. 7 illustrates the Institute of Electrical and Electronics Engineers (IEEE) 754 standard floating-point numbers. A number in IEEE 754 double-precision 64-bit floating point format 701 consists of 52 bits representing the mantissa 707, 11 bits representing the exponent 706, and one sign bit 705 as the left-most bit. A special combination of exponent 706 bits, “111 1111 1111”, identifies a floating-point object NaN (“not a number”). An infinite floating-point value is represented by setting all mantissa 707 bits to 0.

Further referring to FIG. 7, other embodiments may use a number in IEEE 754 single-precision 32-bit floating point format 700, which consists of 23 bits representing the mantissa 704, 8 bits representing the exponent 703, and one sign bit 702 as the left-most bit. A special combination of exponent 703 bits, “1111 1111”, identifies a floating-point object NaN (“not a number”). An infinite floating-point value is represented by setting all mantissa 704 bits to 0.

Next, the IEEE 754 representation of the floating-point value 602 is divided into a plurality of ordered chunks of plaintext 603. In this exemplary embodiment, each ordered chunk of plaintext is 4 bytes in length. To preserve the order of the bits in IEEE 754 64-bit representation 602, each ordered chunk of plaintext 603 includes an ordinal byte (underlined in chunks 603 in FIG. 6) as the left most byte indicating the ordinal relationship of the plurality of ordered chunks of plaintext 603. An initial ordered chunk of plaintext of the plurality of ordered chunks of plaintext includes the sign bit and the exponent bits of the IEEE 754 64-bit representation 602 with an ordinal byte 0x01 prepended to the sign bit and the exponent bits because they represent the left most 12 bits in IEEE 754 64-bit representation 602, and placing the resulting bytes into a first chunk of bytes 603(A). The subsequent ordered chunks of plaintext 603(B) and 603(C) include a leading ordinal byte 0x02 and 0x03, respectively, reflecting their ordinal relationship to one another followed by 24 bits from the mantissa of IEEE 754 64-bit representation 602. Finally, the remaining 4 bits from the mantissa of IEEE 754 64-bit representation 602 are placed in ordered chunk of plaintext 603(D), which has a 0x04 first byte prepended therein to denote the ordinal relationship of chunk 603(D) to 603(A) through 602(C). The remaining bits of ordered chunk of plaintext 603(D) are filled in with zeros.

Next, each ordered chunk of plaintext 603(A) through 603(D) is encrypted with a cryptographic key, e.g., cryptographic key K, using an OPE as discussed above with respect to step 104 of method 100 (see FIG. 1) to generate a plurality of chunks of ciphertext 604. As illustrated in FIG. 6, encrypting ordered chunk of plaintext 603(A) (“01 40 20 00”) generates a chunk of ciphertext 604(A) (“90210776178494257”), encrypting ordered chunk of plaintext 603(B) (“02 a9 72 b8”) generates a chunk of ciphertext 604(B) (“191973543527667137”), encrypting ordered chunk of plaintext 603(C) (“03 db 3a Oc”) generates a chunk of ciphertext 604(C) (“278120542794644833”), and encrypting ordered chunk of plaintext 603(D) (“04 40 00 00”) generates a chunk of ciphertext 604(D) (“306491012625030021”).

Lastly, the plurality of chunks of ciphertext 604(A) through 604 D) are concatenated to generate a ciphertext value 605. Each chunk of ciphertext 604(A), 604(B), 604(C), and 604(D) is appended end-to-end according to the leading ordinal bytes of the corresponding ordered chunks of plaintext 603(A), 603(B), 603(C), and 603(D). Given the ordinal relationship of the plurality of chunks of plaintext is 603(A)|603(B)|603(C)|603(D), the chunks of ciphertext are concatenated according to 604(A)|604(B)|604(C)|604(D). Applying this to the exemplary embodiment shown in FIG. 6, a cipher value 605 is “90210776178494257191973543527667137278120542794644833306491012625030021”.

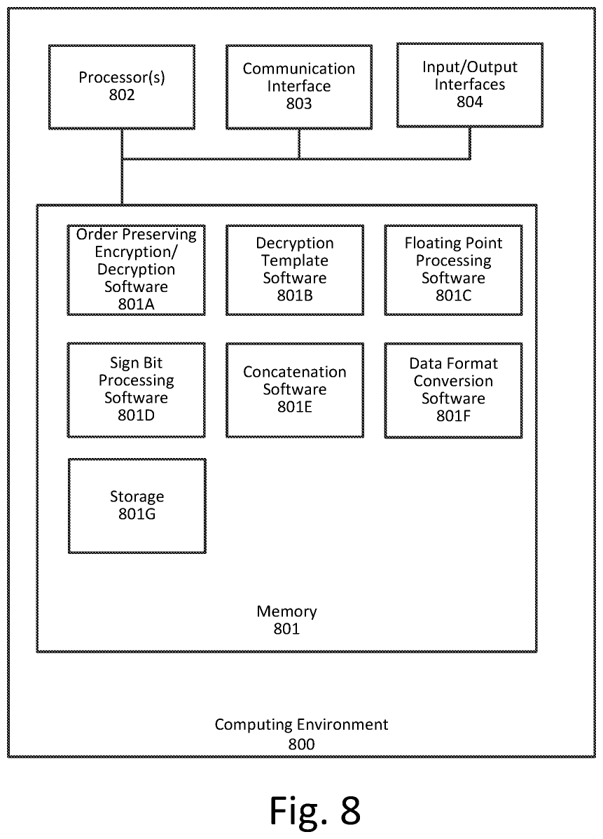

FIG. 8 illustrates a specialized computing environment for format-preserving encryption of a numerical value according to an exemplary embodiment. Computing environment 800 includes a memory 801 that is a non-transitory computer-readable medium and can be volatile memory (e.g., registers, cache, RAM), non-volatile memory (e.g., ROM, EEPROM, flash memory, etc.), or some combination of the two.

As shown in FIG. 8, memory 801 stores order preserving encryption/decryption software 801A, decryption template software 801B, floating point value processing software 801C, sign bit processing software 801D, concatenation software 801E, and data format conversion software 801F. The software stores specialized instructions and data structures configured to perform the order preserving encryption and decryption techniques described herein.

Memory 801 additionally includes a storage 801G that can be used to store encrypted or decrypted values, intermediate values required for encryption or decryption (such as chunks of plaintext values and chunks of ciphertext values), and encryption and/or decryption keys.

All of the software stored within memory 801 can be stored as a computer-readable instructions, that when executed by one or more processors 802, cause the processors to perform the functionality described with respect to FIGS. 1-6.

Processor(s) 802 execute computer-executable instructions and can be a real or virtual processors. In a multi-processing system, multiple processors or multicore processors can be used to execute computer-executable instructions to increase processing power and/or to execute certain software in parallel.

The computing environment additionally includes a communication interface 803, such as a network interface, which is used to monitor network communications, communicate with devices, applications, or processes on a computer network or computing system, collect data from devices on the network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Computing environment 800 further includes input and output interfaces 804 that allow users (such as system administrators) to provide input to the system and display or otherwise transmit information for display to users. For example, input/output interfaces 804 can be used to configure encryption/decryption rules and settings, and perform lookups of system information used in the above-described processes.

An interconnection mechanism (shown as a solid line in FIG. 8), such as a bus, controller, or network interconnects the components of the computing environment 800.

Input and output interfaces 804 can be coupled to input and output devices. The input device(s) can be a touch input device such as a keyboard, mouse, pen, trackball, touch screen, or game controller, a voice input device, a scanning device, a digital camera, remote control, or another device that provides input to the computing environment. The output device(s) can be a display, television, monitor, printer, speaker, or another device that provides output from the computing environment 800. Displays can include a graphical user interface (GUI) that presents options to users such as system administrators for configuring encryption and decryption processes.

The computing environment 800 can additionally utilize a removable or nonremovable storage, such as magnetic disks, magnetic tapes or cassettes, CD-ROMs, CD-RWs, DVDs, USB drives, or any other medium which can be used to store information and can be accessed within the computing environment 800.

The computing environment 800 can be a set-top box, personal computer, a client device, a database or databases, or one or more servers, for example a farm of networked servers, a clustered server environment, or a cloud network of computing devices and/or distributed databases.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices for order preserving encryption of a plaintext value, the method comprising:
storing the plaintext value comprising a plurality of bits arranged in a predefined order;
dividing the plaintext value into a plurality of ordered chunks of plaintext, wherein an initial ordered chunk of plaintext comprises an initial portion of bits in the plurality of bits and wherein each subsequent ordered chunk of plaintext comprises a subsequent portion of bits in the plurality of bits;
encrypting, by an order preserving encryption algorithm, each ordered chunk of plaintext to generate a plurality of ciphertext chunks, each ciphertext chunk comprising a plurality of ciphertext bits; and
concatenating the plurality of ciphertext chunks with one another to generate a ciphertext value.

2. The method of claim 1, wherein dividing the plaintext value into a plurality of ordered chunks of plaintext comprises:
interpreting one or more of the plurality of ordered chunks of plaintext as an integer value;
determining that the integer value is a negative value; and
multiplying the integer value by negative one.

3. The method of claim 1, further comprising:
generating a plurality of decryption templates, each decryption template corresponding to a respective ordered chunk of plaintext, wherein the decryption template comprises data about a length of the respective ordered chunk of plaintext, data about a length of a respective chunk of ciphertext corresponding to the respective ordered chunk of plaintext, and a flag indicating whether an integer representation of a respective chunk of plaintext is negative.

4. The method of claim 3, further comprising:
concatenating the plurality of decryption templates to generate a concatenated decryption template;
encrypting, by a standard encryption algorithm, the concatenated decryption template to generate an encrypted template.

5. The method of claim 4, further comprising:
decrypting the encrypted template to generate the concatenated decryption template;
dividing the ciphertext value into the plurality of ciphertext chunks and dividing the concatenated decryption template into the plurality of decryption templates, wherein a length of each ciphertext chunk is determined from each respective decryption template in the plurality of decryption templates;
decrypting the plurality of ciphertext chunks based at least in part on each respective decryption template to generate the plurality of chunks of plaintext; and
generating the plaintext value by concatenating the plurality of chunks of plaintext with one another.

6. The method of claim 1, wherein,
the plaintext value comprises a floating-point value comprising a sign bit, a plurality of exponent bits, and a plurality of fraction bits,
the initial chunk of ordered plaintext further comprises an ordinal followed by the sign bit and the plurality of exponent bits of the floating-point value; and
each subsequent ordered chunk of plaintext further comprises an ordinal and a portion of the plurality of fraction bits of the floating-point value.

7. The method of claim 6, wherein the plurality of fraction bits are divided among three ordered chunks of plaintext.

8. The method of claim 6, wherein the plurality of fraction bits are divided among two ordered chunks of plaintext.

9. The method of claim 1, wherein the order preserving encryption is one-way encryption.

10. An apparatus for order preserving encryption of a plaintext value, the apparatus comprising:
one or more processors; and
one or more memories operatively coupled to at least one of the one or more processors and having instructions stored thereon that, when executed by at least one of the one or more processors, cause at least one of the one or more processors to:
store the plaintext value comprising a plurality of bits arranged in a predefined order;
divide the plaintext value into a plurality of ordered chunks of plaintext, wherein an initial ordered chunk of plaintext comprises an initial portion of bits in the plurality of bits and wherein each subsequent ordered chunk of plaintext comprises a subsequent portion of bits in the plurality of bits;
encrypt, by an order preserving encryption algorithm, each ordered chunk of plaintext to generate a plurality of ciphertext chunks, each ciphertext chunk comprising a plurality of ciphertext bits; and
concatenate the plurality of ciphertext chunks with one another to generate a ciphertext value.

11. The apparatus of claim 10, wherein the instructions that, when executed by at least one of the one or more processors, cause at least one of the one or more processors to divide the plaintext value into a plurality of ordered chunks of plaintext further cause at least one of the one or more processors to:
interpret one or more of the plurality of ordered chunks of plaintext as an integer value;
determine that the integer value is a negative value; and
multiply the integer value by negative one.

12. The apparatus of claim 10, wherein at least one of the one or more memories has further instructions stored thereon that, when executed by at least one of the one or more processor, cause at least one of the one or more processors to:
generate a plurality of decryption templates, each decryption template corresponding to a respective ordered chunk of plaintext, wherein the decryption template comprises data about a length of the respective ordered chunk of plaintext, data about a length of a respective ciphertext chunk corresponding to the respective ordered chunk of plaintext, and a flag indicating whether an integer representation of a respective chunk of plaintext is negative;
concatenate the plurality of decryption templates to generate a concatenated decryption template; and
encrypt, by a standard encryption algorithm, the concatenated decryption template to generate an encrypted template.

13. The apparatus of claim 12, wherein at least one of the one or more memories has further instructions stored thereon that, when executed by at least one of the one or more processor, cause at least one of the one or more processors to:
decrypt the encrypted template to generate the concatenated decryption template;
divide the ciphertext value into the plurality of ciphertext chunks and divide the concatenated decryption template into the plurality of decryption templates, wherein a length of each ciphertext chunk is determined from each respective decryption template in the plurality of decryption templates;
decrypt the plurality of ciphertext chunks based at least in part on each respective decryption template to generate the plurality of chunks of plaintext; and
generate the plaintext value by concatenating the plurality of chunks of plaintext with one another.

14. The apparatus of claim 10, wherein,
the plaintext value comprises a floating-point value comprising a sign bit, a plurality of exponent bits, and a plurality of fraction bits,
the initial chunk of ordered plaintext further comprises an ordinal followed by the sign bit and the plurality of exponent bits of the floating-point value; and
each subsequent ordered chunk of plaintext further comprises an ordinal and a portion of the plurality of fraction bits of the floating-point value.

15. At least one non-transitory computer-readable medium storing computer-readable instructions that, when executed by at least one of one or more computing devices, cause at least one of the one or more computing devices to:
store a plaintext value comprising a plurality of bits arranged in a predefined order;
divide the plaintext value into a plurality of ordered chunks of plaintext, wherein an initial ordered chunk of plaintext comprises an initial portion of bits in the plurality of bits and wherein each subsequent ordered chunk of plaintext comprises a subsequent portion of bits in the plurality of bits;
encrypt, by an order preserving encryption algorithm, each ordered chunk of plaintext to generate a plurality of ciphertext chunks, each ciphertext chunk comprising a plurality of ciphertext bits; and
concatenate the plurality of ciphertext chunks with one another to generate a ciphertext value.

16. The at least one non-transitory computer-readable medium of claim 15, wherein the instructions that, when executed by at least one of the one or more computing devices, cause at least one of the one or more computing devices to divide the plaintext value into a plurality of ordered chunks of plaintext further cause at least one of the one or more computing devices to:
interpret one or more of the plurality of ordered chunks of plaintext as an integer value;
determine that the integer value is a negative value; and
multiply the integer value by negative one.

17. The at least one non-transitory computer-readable medium of claim 15, further storing computer-readable instructions that, when executed by at least one of the one or more computing devices, cause at least one of the one or more computing devices to:
generate a plurality of decryption templates, each decryption template corresponding to a respective ordered chunk of plaintext, wherein the decryption template comprises data about a length of the respective ordered chunk of plaintext, data about a length of a respective ciphertext chunk corresponding to the respective ordered chunk of plaintext, and a flag indicating whether an integer representation of a respective chunk of plaintext is negative;
concatenate the plurality of decryption templates to generate a concatenated decryption template; and
encrypt, by a standard encryption algorithm, the concatenated decryption template to generate an encrypted template.

18. The at least one non-transitory computer-readable medium of claim 17, further storing computer-readable instructions that, when executed by at least one of the one or more computing devices, cause at least one of the one or more computing devices to:
decrypt the encrypted template to generate the concatenated decryption template;
divide the ciphertext value into the plurality of ciphertext chunks and divide the concatenated decryption template into the plurality of decryption templates, wherein a length of each ciphertext chunk is determined from each respective decryption template in the plurality of decryption templates;
decrypt the plurality of ciphertext chunks based at least in part on each respective decryption template to generate the plurality of chunks of plaintext; and
generate the plaintext value by concatenating the plurality of chunks of plaintext with one another.

19. The at least one non-transitory computer-readable medium of 15, wherein,
the plaintext value comprises a floating-point value comprising a sign bit, a plurality of exponent bits, and a plurality of fraction bits,
the initial chunk of ordered plaintext further comprises an ordinal followed by the sign bit and the plurality of exponent bits of the floating-point value; and
each subsequent ordered chunk of plaintext further comprises an ordinal and a portion of the plurality of fraction bits of the floating-point value.

20. The at least one non-transitory computer-readable medium of claim 19, wherein the plurality of fraction bits are divided among three ordered chunks of plaintext.
